(19) United States
(12) Patent Application Publication
(10) Pub. No.: US 2014/0331640 A1
(43) Pub. Date: Nov. 13, 2014

(54) LEAN FUEL INTAKE GAS TURBINE ENGINE

(71) Applicant: KAWASAKI JUKOGYO KABUSHIKI KAISHA, Kobe-shi, Hyogo (JP)

(72) Inventors: Soh Kurosaka, Kobe-shi (JP); Yoshihiro Yamasaki, Kobe-shi (JP); Hikaru Sano, Kobe-shi (JP); Yasushi Doura, Kobe-shi (JP); Yoshitaka Minami, Kakogawa-shi (JP)

(73) Assignee: KAWASAKI JUKOGYO KABUSHIKI KAISHA, Kobe-shi, Hyogo (JP)

(21) Appl. No.: 14/362,224

(22) PCT Filed: Nov. 28, 2012
(86) PCT No.: PCT/JP2012/080680

§ 371 Date: Jun. 2, 2014

(30) Foreign Application Priority Data
Dec. 5, 2011 (JP) 2011-265522

(51) Int. Cl. F02C 3/04

(52) U.S. Cl. CPC F02C 3/04
USPC 60/39.12

(57) ABSTRACT

A lean fuel intake gas turbine engine includes a compressor to compress a working gas at a concentration equal to or lower than the flammable limit concentration to thereby generate a compressed gas, a catalytic combustor to burn the compressed gas through a catalytic reaction, a turbine driven by a combustion gas from the catalytic combustor, a heat exchanger to heat, by means of an exhaust gas from the turbine, the compressed gas that is introduced from the compressor into the catalytic combustor, a heat exchanger bypass valve to communicate between inlet and outlet sides of the heat exchanger, a first catalyst outlet temperature control unit to open the heat exchanger bypass valve in the event that the outlet temperature of the catalytic combustor attains a value equal to or higher than an outlet prescribed value.

### CROSS REFERENCE TO THE RELATED APPLICATION

This application is based on and claims Convention priority to Japanese patent application No. 2011-265522, filed Dec. 5, 2011, the entire disclosure of which is herein incorporated by reference as a part of this application.

### BACKGROUND OF THE INVENTION

1. Field of the Invention

The present invention relates to a lean fuel intake gas turbine engine of a type, in which a low calorie gas of a kind having a variable fuel concentration such as, for example, a methane gas produced in coal mines and reclaimed lands or landfills is introduced into an engine as an air-fuel mixture of a concentration lower than the flammable limit concentration at which the air-fuel mixture will be ignited by compression in a compressor, to allow a flammable component, contained therein, to be used as a fuel.

2. Description of Related Art

The lean fuel intake gas turbine engine is generally so designed and so configured that a working gas containing fuel and having a concentration equal to or lower than the flammable limit concentration is compressed by a compressor and is, after the compressed gas has been combusted by a catalytic combustor, supplied to the turbine to drive the latter. The compressed gas introduced from the compressor into the catalytic combustor is heated by a heat exchanger that utilizes an exhaust gas emerging from the turbine. In this respect, see, for example, the patent document 1 listed below.

As a fuel for this kind of lean fuel intake gas turbine engine, a working gas is used, in which ventilation air methane (VAM) and coal mine methane (CMM), both exhausted from coal mines, are mixed together. The ventilation air methane has a low fuel concentration (methane concentration being lower than 1%) and has a small fluctuation band whereas the coal mine methane has a high fuel concentration (methane concentration being 10 to 30%) and has a large fluctuation band. If the fuel concentration of the working gas, which is an intake air of the gas turbine engine, that is, the fuel concentration of a compressed gas being introduced into a catalytic combustor increases, the catalytic combustor may possibly burn down and, conversely, if the fuel concentration decreases, failure to burn may possibly occur in the catalytic combustor.

Also, in the lean fuel intake gas turbine engine, in order to maintain a catalyst inlet temperature at a constant value under a low loaded condition, a control is made in such a manner that the number of revolutions of the engine is generally reduced to reduce the flow of the intake air so that the exhaust temperature, that is, a heat exchanger inlet temperature will not be lowered. However, in the event of fluctuation of the load, the control operation may fail to go along the fluctuation of the CMM fuel concentration and/or the fluctuation of the load, due to delay in function of a CMM fuel control valve or delay in function of the heat exchanger and the catalyst combustor. As a result, in the event that the fuel concentration and/or the heat exchanger inlet temperature are too high, the possibility of the catalytic combustor being burned down may increase, whereas in the event that the fuel concentration and/or the heat exchanger inlet temperature are too low, the possibility of failure of the catalytic combustor to ignite may increase.

### PRIOR ART LITERATURE

Patent Document 1: Japanese Patent No. 4751950

As countermeasures hitherto employed against the possible burn-down of the catalytic combustor, the fuel supply is shut down in the event of the catalyst outlet temperature exceeding a predetermined value to thereby halt the operation of the gas turbine engine. Also, as countermeasures hitherto employed against the failure to ignite in the catalytic combustor, the fuel supply is shut down, in the event that the difference in temperature between a catalyst outlet and a catalyst inlet decreases below a predetermined value, to thereby halt the operation of the gas turbine engine. It has, however, been found that those countermeasures are incapable of ensuring the stable operation because the gas turbine engine is frequently shut down when the CMM fuel concentration and/or the load change frequently.

### SUMMARY OF THE INVENTION

In view of the foregoing, the present invention has devised to substantially eliminate the foregoing problems and inconveniences and is therefore intended to provide a lean fuel intake gas turbine engine capable of being stably operated by avoiding the burn-down of the catalytic combustor and the failure to ignite in the catalytic combustor even when the fuel concentration and the load undergo fluctuations.

In order to accomplish the foregoing object, the present invention provides a lean fuel intake gas turbine engine which includes a compressor to compress a working gas, of which fuel concentration tends to fluctuate, at a concentration equal to or lower than a flammable limit concentration to thereby generate a compressed gas, a catalytic combustor to burn the compressed gas through a catalytic reaction to thereby generate a combustion gas, a turbine driven by the combustion gas from the catalytic combustor to thereby generate an exhaust gas, a heat exchanger to heat, by means of the exhaust gas from the turbine, the compressed gas that is introduced from the compressor into the catalytic combustor, a heat exchanger bypass valve to communicate between a compressed gas inlet side and a compressed gas outlet side of the heat exchanger, and a first catalyst outlet temperature control unit to open the heat exchanger bypass valve in the event that an outlet temperature of the catalytic combustor attains a value equal to or higher than an outlet prescribed value.

According to the foregoing, in the event that the catalyst outlet temperature is equal to or higher than the prescribed value, the heat exchanger bypass valve is opened to lower the catalyst inlet temperature so that the undesirable burn-down of the catalytic combustor can be avoided. Also, in the event that the catalyst outlet temperature is lower than the prescribed value, the heat exchanger bypass valve is closed to increase the catalyst inlet temperature so that the failure to ignite in the catalytic combustor can be avoided. Accordingly, it is possible to stably run even at the time of fluctuation of the fuel concentration and the load while avoiding the burn-down of the catalytic combustor and the combustor's failure to ignite.

In a preferred embodiment of the present invention, the lean fuel intake gas turbine engine may include a concentration adjusting unit which is operable to lower the fuel concentration of the working gas in the event that the outlet temperature of the catalytic combustor attains a value equal to or higher than the outlet prescribed value. The use of the concentration adjusting unit is effective in that the burn-down of the catalytic combustor can be effectively avoided when respective control of the concentration adjusting unit and the heat exchanger bypass valve are combined together.

In another preferred embodiment of the present invention, the lean fuel intake gas turbine engine may include a catalyst inlet temperature control unit to close the heat exchanger bypass valve in the event that, while the heat exchanger bypass valve is opened, an inlet temperature of the catalytic combustor attains a value equal to or lower than an inlet prescribed value. The use of the catalyst inlet temperature control unit is effective in that the catalytic combustor's failure to ignite can be effectively avoided by closing the heat exchanger bypass valve to allow the catalyst inlet temperature to increase when the catalyst inlet temperature is equal to or lower than the inlet prescribed value.

In a further preferred embodiment of the present invention, the working gas may be prepared by mixing a plurality of fuel gases having different fuel concentrations, in which case the use is made of a second catalyst outlet temperature control unit to suppress an amount of supply of one or more fuels, having a high fuel concentration, in the event that the outlet temperature of the catalyst combustor attains a value equal to or higher than the outlet prescribed value. According to this structural feature, even when the plurality of fuel gases having different fuel concentrations are mixed together, suppression of the amount of supply of one or more fuels having the high fuel concentration is effective to facilitate the avoidance of the burn-down of the catalytic combustor.

In a still further preferred embodiment of the present invention, the working gas may include a mixture of ventilation air methane (VAM) and coal mine methane (CMM). If the working gas is prepared from the mixture of the ventilation air methane and the coal mine methane, it is possible to refrain the VAM and the CMM from being emitted to the atmosphere and to achieve an effective utilization as a fuel.

Any combination of at least two constructions, disclosed in the appended claims and/or the specification and/or the accompanying drawings should be construed as included within the scope of the present invention. In particular, any combination of two or more of the appended claims should be equally construed as included within the scope of the present invention.

### BRIEF DESCRIPTION OF THE DRAWINGS

In any event, the present invention will become more clearly understood from the following description of preferred embodiments thereof, when taken in conjunction with the accompanying drawings. However, the embodiments and the drawings are given only for the purpose of illustration and explanation, and are not to be taken as limiting the scope of the present invention in any way whatsoever, which scope is to be determined by the appended claims. In the accompanying drawings, like reference numerals are used to denote like parts throughout the several views, and:

FIG. 1 is a block diagram showing a schematic structure of a lean fuel intake gas turbine engine designed in accordance with a preferred embodiment of the present invention; and

FIG. 2 is a block diagram showing a schematic structure of a control device for the gas turbine engine shown in FIG. 1.

### DESCRIPTION OF PREFERRED EMBODIMENTS

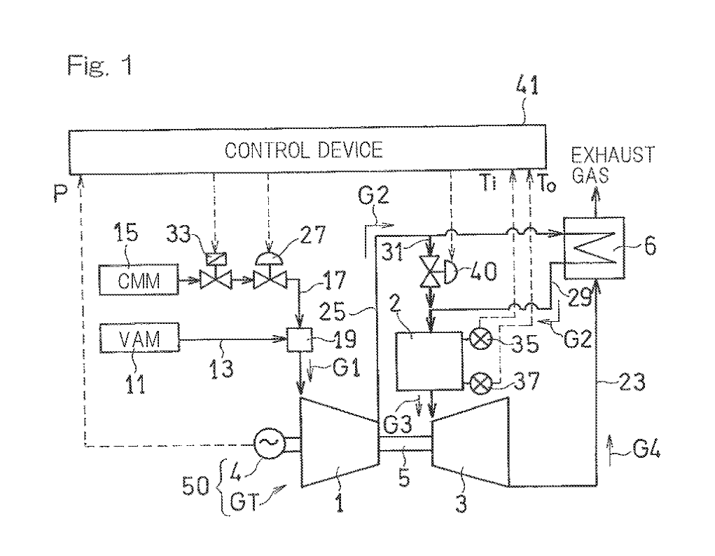

A preferred embodiment of the present invention will now be described with particular reference to the accompanying drawings. FIG. 1 illustrates a schematic structural diagram showing a lean burn fuel intake gas turbine engine GT designed in accordance with the preferred embodiment of the present invention. The illustrated gas turbine engine GT includes a compressor 1, a catalytic combustor 2 containing a catalyst such as, for example, platinum and/or palladium, and a turbine 3. An electric power generator 4 is driven by the gas turbine engine GT.

For a low calorie gas used in the gas turbine engine GT, a working gas G1 is used which is prepared by mixing two fuel gases having different fuel concentrations, such as, for example, a ventilation air methane (VAM), produced in coal mines, and a coal mine methane (CMM) having a higher concentration of a flammable component (methane) than that in the ventilation air methane. The working gas G1 has its fuel concentration that is considerably variable depending on the condition of a coal mine. The working gas G1 is introduced into an intake port of the gas turbine engine GT and is then compressed by the compressor 1 to provide a high pressure compressed gas G2 which is in turn supplied to the catalytic combustor 2. This compressed gas G2 is burned to provide a combustion gas G3 as a result of the catalytic reaction of such catalyst within the catalytic combustor 2 as, for example, platinum and/or palladium. The high temperature, high pressure combustion gas G3 emitted from the catalytic combustor 2 is then supplied to the turbine 3 to drive the latter. The turbine 3 is drivingly connected with the compressor 1 through a rotary shaft 5 and, accordingly the compressor 1 is driven by the turbine 3. In this way an electric power generating device 50 including the gas turbine engine GT and the electric power generator 4 is formed.

The gas turbine engine GT has an exhaust passage 23 having a heat exchanger 6 disposed thereon. This heat exchanger 6 is operable to heat the compressed gas G2, introduced from the compressor 1 into the catalytic combustor 2, by a exhaust gas G4 from the gas turbine engine GT.

A fuel supply system towards the gas turbine engine GT mixes the ventilation air methane, having a low methane concentration (lower than 1%, but normally about 0.5%), with a suitable quantity of the coal mine methane, having a higher methane concentration (normally 20 to 30%) than that of the ventilation air methane, and then supplies the resultant mixture to the compressor 1. Specifically, the fuel supply system includes a main fuel supply passage 13 extending from a VAM supply source 11 to the compressor 1, and an auxiliary fuel supply passage 17 communicating from a CMM supply source 15 to the main fuel supply passage 13 by way of various valves as will be described later. Mixing of the coal mine methane from the auxiliary fuel supply passage 17 to the main fuel supply passage 13 is carried out by a mixer 19 provided on the main fuel supply passage 13.

The auxiliary fuel supply passage 17 is provided with a CMM fuel control valve 27 for adjusting the flow of the CMM fuel and a fuel shutoff valve 33 for shutting off the flow of the CMM fuel. The CMM fuel control valve 27 forms a concentration adjusting unit for adjusting the fuel concentration of the working gas G1.

There is provided a bypass passage 31 for communicating between a compressed gas inlet passage 25, which connects between the compressor 1 and the heat exchanger 6, and a compressed gas outlet passage 25, which connects between the heat exchanger 6 and the catalytic combustor 2. A heat exchanger bypass valve 40 is provided in the bypass passage 31. The details of the heat exchanger bypass valve 40 will be described later. Also, a catalyst inlet thermometer 25 and a catalyst outlet thermometer 37 are provided at respective inlet and outlet of the catalytic combustor 2.

Temperature values detected respectively by the catalyst inlet thermometer 35 and the catalyst outlet thermometer 37 are fed to a control device 41. Also, an electric power output value of the electric power generator 4 is fed to the control device 41. The control device 41, based on those input values, adjusts the CMM fuel control valve 27, the fuel shutoff valve 33 and the heat exchanger bypass valve 40 to thereby control the temperature of the compressed gas G2 to be supplied to the inlet of the catalytic combustor 2.

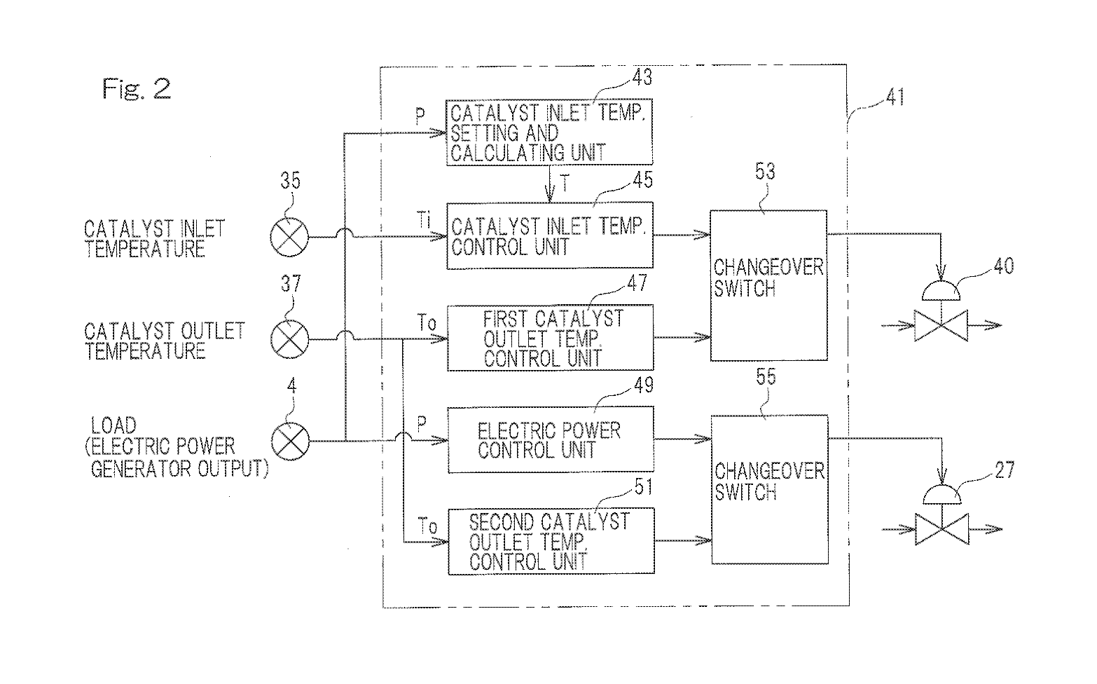

In the description that follows, a specific control logic of the control device 41 will be described. As shown in FIG. 2, the control device 41 includes a catalyst inlet temperature setting and calculating unit 43 for setting an optimum catalyst inlet temperature T from a load P of the electric power generator 4, a catalyst inlet temperature control unit 45 for controlling the heat exchanger bypass valve 40 from the preset optimum catalyst inlet temperature T and a measured value Ti of the catalyst inlet thermometer 35, a first catalyst outlet temperature control unit for executing a temperature control of the heat exchanger bypass valve 40 on the basis of a measured value To of the catalyst outlet thermometer 37, an electric power control unit 49 for executing a control of the CMM fuel control valve 27 in dependence on the load P of the electric power generator 4, and a second catalyst outlet temperature control unit 51 for executing a control of the CMM fuel control valve 27 on the basis of the measured value To of the catalyst outlet thermometer 37. The control device 41 also includes a bypass valve changeover switch 53 for selectively setting a control mode of the heat exchanger bypass valve 40 to a catalyst inlet temperature control or to a first catalyst outlet temperature control and a fuel control valve changeover switch 55 for selectively setting a control mode of the CMM fuel control valve 27 to an electric power control or to a second catalyst outlet temperature control.

In the first place, a control during a normal operation will be described. During the normal operation, the heat exchanger bypass valve 40 is controlled by the catalyst inlet temperature control. In other words, the bypass valve changeover switch 53 is set to the side of the catalyst inlet temperature control unit 45. Specifically, the heat exchanger bypass valve 40 is adjusted in dependence on the measured value of the catalyst inlet thermometer 35 so that a temperature is approached at which the catalyst is stabilized and is therefore ready for the catalytic reaction. The temperature, at which the catalyst is stabilized and is therefore ready for the catalytic reaction, depends on the electric power output, which is a load, that is, the fuel concentration, and therefore, the catalyst inlet temperature setting and calculating unit 43 calculates an optimum catalyst inlet temperature setting value T from a measured value P of the electric power output and render the value T to be a preset value for the catalyst temperature inlet control by the heat exchanger bypass valve 40. So that the measured value Ti of the catalyst inlet thermometer 35 can approach this optimum catalyst inlet temperature T, the heat exchanger bypass valve 40 is adjusted by the catalyst inlet temperature control unit 45.

The CMM fuel control valve 27 during the normal operation is controlled by the electric power control. In other words, the fuel control valve changeover switch 55 is set to the side of the electric power control unit 49. Specifically, the CMM fuel control valve 27 is adjusted by the electric power control unit 49 so that an optimum number of revolution can be attained in dependence on the load P of the electric power generator 4.

In operation including the start of the gas turbine engine, in the event that the measured value To of the catalyst outlet thermometer 37 shown in FIG. 2 attains a value equal to or higher than the catalyst heat resistance temperature because of a factor such as an abrupt increase of the CMM fuel concentration, or an excessive increase of the fuel concentration of the working gas G1 (FIG. 1), or an excessive increase of the temperature (exhaust temperature) of the exhaust gas G4, during the engine revolution speed being varied, the heat exchanger bypass valve 40 and the CMM fuel control valve 27 perform the following respective controls.

With the bypass valve changeover switch 53 set to the side of the first catalyst outlet temperature control unit 47, the control mode of the heat exchanger bypass valve 40 is rendered to be the catalyst outlet temperature control. Specifically, the heat exchanger bypass valve 40 is opened by the first catalyst outlet temperature control unit 47 and the bypass of the compressed gas G2 takes place by communicating the compressed gas inlet passage 25 with the compressed gas outlet passage 29 through the bypass passage 31 shown in FIG. 1. By so doing, the compressed gas G2 of a low temperature before being passed through the heat exchanger 6 is mixed with the compressed gas G2 which has been boosted in temperature as it flows past the heat exchanger 6 and, therefore, the temperature of the compressed gas G2 to be introduced into the catalytic combustor 2, that is, the temperature of the catalytic inlet thermometer 35 is lowered. As a result, the temperature of the catalyst outlet thermometer 37 is also lowered. When the measured value To of the catalyst outlet thermometer 37 attains a value equal to or lower than the catalyst heat resistance temperature, the heat exchanger bypass valve 40 is closed by the first catalyst outlet temperature control unit 47 shown in FIG. 2. The catalyst heat resistance temperature is, for example, about 950° C. and the optimum catalyst outlet temperature is, for example, within the range of about 700 to 900° C.

Simultaneously, the fuel control valve changeover switch 55 is changed to the side of the second catalyst outlet temperature control unit 51 to render the control mode of the CMM fuel control valve 27 to the catalyst outlet temperature control. Specifically, the CMM fuel control valve 27 is closed by the second catalyst outlet temperature control unit 51 and, as a result that the methane concentration of the working gas G1 supplied to the gas turbine engine GT shown in FIG. 1 is therefore lowered, the temperature of the catalyst outlet thermometer 37 is lowered. When the measured value To of the catalyst outlet thermometer 37 attains a value equal to or lower than the catalyst heat resistance temperature, the CMM fuel control valve 27 is opened by the second catalyst outlet temperature control unit 51 shown in FIG. 2. In the embodiment now under discussion, with both of the heat exchanger bypass valve 40 and the CMM fuel control valve 27 being controlled simultaneously, the catalyst outlet temperature is lowered, but the control of the CMM fuel control valve 27 may be omitted and, instead, only the control of the heat exchanger bypass valve 40 may survive.

Also, in operation (with the heat exchanger bypass valve 40 being opened) including the start of the gas turbine engine, in the event that the measured value Ti of the catalyst inlet thermometer 35 attains a low temperature value enough to hamper the catalyst from undergoing the catalytic reaction because of a factor such as an abrupt decrease of the CMM fuel concentration, or an excessive decrease of the fuel concentration of the working gas G1 (shown in FIG. 1), or an excessive decrease of the temperature of the exhaust gas G4, during the engine speed being varied, the heat exchanger bypass valve 40 performs the following control.

With the bypass valve changeover switch 53 of FIG. 2 switched over to the side of the catalyst inlet temperature control unit 45, the control mode of the heat exchanger bypass valve 40 is rendered to be the catalyst inlet temperature control. Specifically, the heat exchanger bypass valve 40 is closed by the catalyst inlet temperature control unity 45 and the temperature of the catalyst inlet thermometer 35 then increases. Accordingly, the measured value Ti of the catalyst inlet thermometer 35 is rendered to be a temperature at which the catalytic reaction takes place. The optimum catalyst inlet temperature T is, for example, about 400° C. It is to be noted that the catalyst inlet temperature control unit 45 may be omitted and the heat exchanger bypass valve 40 may be closed when the outlet temperature To of the catalytic combustor 2 attains a value equal to or lower than the prescribed value that is lower than the outlet prescribed value.

In the construction described hereinabove, in the event that the measured value To of the catalyst outlet thermometer 37 attains a value equal to or higher than the catalyst heat resistance temperature, the heat exchanger bypass valve 40 is opened to allow the catalyst inlet temperature to be lowered, and as a result, the burn-down of the catalytic combustor 2 can be avoided. Also, in the event that the measured value Ti of the catalyst inlet thermometer 35 attains a value at which no catalytic reaction takes place, the heat exchanger bypass valve 40 is closed and as a result, the catalyst inlet temperature is increased. By so doing, the catalytic combustor 2 can be avoided from failing to ignite. Accordingly, even at the time the CMM concentration and the load undergo change, the gas turbine engine GT can be stably operated while the burn-down of the catalytic combustor 2 and the failure of the catalytic combustor 2 to ignite are avoided.

Furthermore, in the event that the measured value To of the catalyst outlet thermometer 37 attains a value equal to or higher than the catalyst heat resistance temperature, closure of the CMM fuel control valve 27 is effective to lower the methane concentration of the working gas G1 to allow the burn-down of the catalytic combustor 2 to be prevented effectively. Thus, by suppressing the only amount of supply of the coal mine methane having a high fuel concentration, the burn-down of the catalytic combustor 2 can be easily avoided.

Yet, since the ventilation air methane and the coal mine methane are utilized as the working gas G1, the undesirable emission of the ventilation air methane and the coal mine methane to the atmosphere can be avoided, and also, the effective utilization as a fuel can be achieved.

It is to be noted that the working gas G1 may be a mixture of three or more fuel gases, for example, the ventilation air methane, the coal mine methane and the natural gas, and, in any event, the working gas G1 may be an air-fuel mixture of a kind in which the fuel concentration changes. Where the three or more fuel gases are employed, in the event that the catalyst outlet temperature To attains a value equal to or higher than the catalyst heat resistance temperature, a control has to be made so that the gas supply amount of one or more fuel gases, which is rich in concentration, be controlled.

Although the present invention has been fully described in connection with the preferred embodiments thereof with reference to the accompanying drawings which are used only for the purpose of illustration, those skilled in the art will readily conceive numerous changes and modifications within the framework of obviousness upon the reading of the specification herein presented of the present invention. Accordingly, such changes and modifications are, unless they depart from the scope of the present invention as delivered from the claims annexed hereto, to be construed as included therein.

### REFERENCE NUMERALS

1 . . . Compressor

2 . . . Catalytic combustor

3 . . . Turbine

4 . . . Electric power generator

6 . . . Heat exchanger

27 . . . CMM fuel control valve (Concentration Adjusting Unit)

35 . . . Catalyst inlet thermometer

37 . . . Catalyst outlet thermometer

40 . . . Heat exchanger bypass valve

41 . . . Control device

45 . . . Catalyst inlet temperature control unit

47 . . . First catalyst outlet temperature control unit

51 . . . Second catalyst outlet temperature control unit

GT . . . Lean fuel intake gas turbine engine

G1 . . . Working gas

G2 . . . Compressed gas

G3 . . . Combustion gas

G4 . . . Exhaust gas

What is claimed is:

1. A lean fuel intake gas turbine engine which comprises:
a compressor to compress a working gas, of which fuel concentration tends to fluctuate, at a concentration equal to or lower than a flammable limit concentration to thereby generate a compressed gas;
a catalytic combustor to burn the compressed gas through a catalytic reaction to thereby generate a combustion gas;
a turbine driven by the combustion gas from the catalytic combustor to thereby generate an exhaust gas;
a heat exchanger to heat, by means of the exhaust gas from the turbine, the compressed gas that is introduced from the compressor into the catalytic combustor;
a heat exchanger bypass valve to communicate between a compressed gas inlet side and a compressed gas outlet side of the heat exchanger, and
a first catalyst outlet temperature control unit to open the heat exchanger bypass valve in the event that an outlet temperature of the catalytic combustor attains a value equal to or higher than an outlet prescribed value.

2. The lean fuel intake gas turbine engine as claimed in claim 1, further comprising a concentration adjusting unit which is operable to lower the fuel concentration of the working gas in the event that the outlet temperature of the catalytic combustor attains a value equal to or higher than the outlet prescribed value.

3. The lean fuel intake gas turbine engine as claimed in claim 1, further comprising a catalyst inlet temperature control unit to close the heat exchanger bypass valve in the event that, while the heat exchanger bypass valve is opened, an inlet temperature of the catalytic combustor attains a value equal to or lower than an inlet prescribed value.

4. The lean fuel intake gas turbine engine as claimed in claim 1, wherein the working gas comprises a plurality of fuel gases having different fuel concentrations, which fuel gases are mixed together,
further comprising a second catalyst outlet temperature control unit to suppress an amount of supply of one or more fuels, having a high fuel concentration, in the event that the outlet temperature of the catalyst combustor attains a value equal to or higher than the outlet prescribed value.

5. The lean fuel intake gas turbine engine as claimed in claim 1, wherein the working gas comprises a mixture of ventilation air methane and coal mine methane.
